(19) United States
(12) Patent Application Publication
(10) Pub. No.: US 2016/0041573 A1
(43) Pub. Date: Feb. 11, 2016

(54) ENERGY MANAGEMENT SYSTEM

(71) Applicant: KOOL KONCEPTS LIMITED, Hong Kong (CN)

(72) Inventors: Andrew Yuen Chin CHEN, Hong Kong (CN); Amy Decem CHENG, Hong Kong (CN); Tsz Kai TAM, Hong Kong (CN)

(21) Appl. No.: 14/775,721

(22) PCT Filed: Mar. 14, 2014
(86) PCT No.: PCT/IB2014/059823

§ 371 Date: Sep. 14, 2015

Related U.S. Application Data
(60) Provisional application No. 61/786,173, filed on Mar. 14, 2013.

(51) Int. Cl. G05F 1/66; G05B 15/02

(52) U.S. Cl. CPC G05F 1/66; G05B 15/02

(57) ABSTRACT

The present invention provides an Energy Management System which can be configured to automatically switch peripheral appliances on or off by detecting master appliances being in standby state, even though these appliances are located far away from each other in a premise, or even in other premises. The system is also capable of detecting whether the included appliances are plugged or unplugged to facilitate simple and efficient management of appliance power consumption for the sake of energy saving. In one embodiment, it also provides a detachable, battery-powered wireless sub-system, supporting dual operation modes, to improve wireless coverage of the system.

### FIELD OF THE INVENTION

The present invention relates generally to systems for the automation of monitoring and controlling electrical appliances to reduce energy consumption and increase energy efficiency for households, offices and institutions.

### BACKGROUND OF THE INVENTION

An energy management system can be a smart meter, a power measuring AC socket, a remote controlled AC socket, a smart power strip, a smart home system, or a campus wide energy management system through network control and monitoring.

A smart meter is a household electricity meter which also has a communication sub-system to provide usage, instant or monthly, to the utility facility for billing and supply planning purposes. It creates a dynamic two-way dialogue between utilities and their customers. This dialogue aims to drive energy efficiency and demand response. Examples available on the market are TENDRIL. The electricity power consumption is a cumulated total per household.

A power measuring AC socket is usually an add-on device, which is inserted between an ordinary AC socket and an appliance under measurement. The device measures the electricity power getting through from the ordinary AC socket to the appliance. The measurement results are usually shown on the display associated on the device. With these results, users can understand how much electricity a particular appliance consumes at any operation modes. Further usage plans can be decided by the users to facilitate energy saving. An example available in the market is Kill-A-Watt.

A remotely controlled AC socket is usually an add-on device, which is inserted between an ordinary AC socket and an appliance. The device usually contains a switch to turn on or off the mains power to the appliance. The device can be controlled remotely through various technologies, such as infra-red, radio frequency wave, power-line signal and so on. Some of the technologies, like modem, router, and the Internet, allow the extension of the control far away from the premises, where the device and the appliance are installed. With this device, the usage of the appliance can therefore be managed remotely to improve energy utilization. An example available in the market is Wayne Dalton.

A smart power strip is an extension of AC sockets, which are usually divided into two kinds, namely master and peripheral. Electric power consumption of the master socket is being monitored. When the appliance plugged into the master socket consumes power less than a threshold (standby power), those peripheral sockets will be switched off automatically to cut further power consumption. On the contrary, when the master socket draws power higher than the threshold (re-activated to normal), those peripheral sockets will be turned on automatically. For example, a computer is plugged into the master socket, while the associated monitor, printer, router, speaker are in the peripheral sockets. Examples available on the market are IntelliPanel and BuLogics.

A smart home system is usually a home wide network which complies of devices such as light switches, AC sockets, door locks, room temperature conditioning thermostat, remote controllers, and so on. Examples available in the market are HAI, EnergyHub and Energate. These devices communicate with each other to form a network, and the networking media can be radio frequency, infra-red, or power-line. These systems mainly address home control automation. Though some of the devices include the power measurement feature, there is usually no proactive energy saving schemes for users to save energy.

A campus wide energy management system utilizes network infrastructure to link up various sub-systems such as power measuring AC sockets and remotely controlled AC sockets, which are installed throughout the campus, which is usually divided into small areas of clusters to facilitate management and operations. A control centre will review the energy usage and control appliance individually or cluster-wise, in order to better utilize the energy consumption. Examples of this system are Cisco's EnergyWise and Agilewaves.

However, each of the above energy management devices has its weakness. For example, the smart meter reports a total electricity usage per household. There is no idea which individual appliance consumes more. This makes energy management difficult and inefficient. The power measuring AC socket tells how much an appliance consumes, but will not proactively help the users about energy saving. Similarly, the remotely controlled AC socket needs users' intervention to switch off so as to save energy. On the contrary, the smart power strip is actively helping users to save energy, as it measures the master appliance and switches off the peripherals automatically. The only drawback is that the master and its peripherals have to be plugged on the same smart strip. A campus wide energy management system is the most complete and automatic solution, but the implementation complexity, equipment cost, maintenance works will overwhelm the benefit of energy saved for a household user.

Hence, there is a need for user-friendly energy management systems which provides flexible functions, keep track of all energy consumption in the system and control of electrical appliances over a large range of distances.

### SUMMARY OF THE INVENTION

The present invention provides a system, which measures the power consumption of each appliance plugged in the system, and is able to remotely switch on or off any appliance plugged in the system. In one embodiment, the software application can be configured to proactively and automatically manage one or many peripheral appliances to switch on or off based on the power consumption of one or many master appliances. These master and peripheral appliances are not necessary to be plugged on the same First Power Socket Device. For example, a configuration can be set to have an Internet router (in living room) and a laser printer (in study room) automatically switched off when all computers (in study room and bedrooms) have been consuming standby power only. In addition, the master and peripheral appliance can be the same appliance, such as a mobile phone charger. When the charging completes and standby power appears, the charger can be automatically switched off to cut its own standby power. In another embodiment, when a plurality of the system are implemented in multiple premises, the master and peripheral appliances can even be located in any physical locations around the world. For example, a video storage network shared hard drive (in a company's headquarter) can be automatically switched when the associated computers (in regional sales offices) are all in standby or off. A scene control is to switch on, off, or dim a group of a plurality of appliances in the system altogether. The system also supports a location based home automation service which can automatically switch on/off a plurality of appliances when the user's portable device is leaving or returning the proximity of the system's installation premises, such as home. This proximity information is derived by the GPS location data of the portable device.

The invention also provides appliance plugged and unplugged detection and notification to the users. Since all the appliances in the system will be monitored and controlled, the correct identification of each appliance is important. This detection and notification is to identify new appliance joining the system, to update the configuration if an appliance has been migrated from one AC socket to another in the system. In one embodiment, the plug and unplug mechanism can be detected electrically through a detection pin bridging the live or neutral prong of an appliance's power plug. With the name assigned to each appliance plugged into an AC socket in the system, the user can easily find which AC socket is with that appliance. When an appliance is to be relocated, it can help correctly and efficiently identify the socket.

Each appliance in the system can be defined with a plurality of schedules, so as to let the system switches that appliance on or off automatically according to the time set.

Features are designed to provide minimal effort and less intervention required by the users to maintain effective and efficient energy saving.

Sensitive and valuable appliances are usually protected by surge arrestors. In one embodiment, the present invention not only provides appliances with a conventional surge arrestor, but also an arrestor failure detection scheme. Once a failure is detected, a push notification will immediately notify the users, e.g. via a smart phone app with a plurality of users registered with the system. Those users can take immediate actions to tackle the outage to guarantee the service.

In one embodiment, the Energy Management System of the present invention is a home- or office-wide network comprising a single Second Power Socket Device with a Detachable Data Transceiver Device, and together with a plurality of First Power Socket Devices. Each of the First Power Socket Device is capable of remote controlling and energy measuring over multiple home or office appliances, such as TV, computers, game consoles, ovens, washing machines, lighting and so on. They communicate wirelessly with the Detachable Data Transceiver Device in the Second Power Socket Device, which then communicate wirelessly with computing devices such as computers and portable devices, such as smart phones or tablet PCs. The software, or apps, runs on computers or portable devices, provides a user interface to manage the energy measurement data and control of those connected appliances. Through modems, routers, and the Internet service providers, the measurement and control can be accessed remotely, even when the user is not at the location where the appliances are located.

In one embodiment, the First Power Socket Device functions as an ordinary power strip (see FIG. 2a, 2b, 2c). It also has the feature of a smart strip. The First Power Socket Device does not classify its AC sockets into master nor peripheral. Since each of the AC sockets on the First Power Socket Device is capable of both power measurement and remote controlling, either a master or peripheral electrical appliance can be plugged into the AC socket depending on system configuration through the software application on computing devices such as computers, or apps on smart phones or tablet PC. Therefore, the invention extends the smart strip feature not limited to one First Power Socket Device, it can be across multiple First Power Socket Devices. That is the master electrical appliance can be on one First Power Socket Device, but the associated peripheral electrical appliances can be on any other First Power Socket Devices wirelessly linked together.

In one embodiment, the First Power Socket Device and the Second Power Socket Device are combined into a single device (see FIG. 3a, 3b, 3c) with a Detachable Data Transceiver Device (see FIG. 4a, 4b), a docking space for the Detachable Data Transceiver Device, and a battery charging circuitry for the Detachable Data Transceiver Device. In one embodiment, the Detachable Data Transceiver Device comprises an industrial standard Wi-Fi module which translates the power measurement data and remote control instructions to and from the Second Power Socket or First Power Socket Devices to be accepted by computers, smart phones and tablet PC which support the Wi-Fi feature, so that PC software and apps can be utilized to control the appliances and to analyze the data through a user friendly and interactive interface, instead of just a traditional button driven remote controller that is almost unable to upgrade with new features in the future. Currently, some home or office automation systems also have similar Wi-Fi translation to allow the use of Wi-Fi enabled computers, smart phones or tablet PC to take the control. However, they join the existing Wi-Fi network. The present invention, in contrast, is capable of creating a new Wi-Fi network if there is no existing Wi-Fi network. Alternatively, the system of the present invention would provide a Wi-Fi network that can cover some blind spots where computing devices such as computers, smart phones or tablet PC are located. In one embodiment, the Detachable Data Transceiver Device is rechargeable battery powered, so it is portable to minimize the chance of having Wi-Fi blind spots.

In one embodiment, the energy management system further comprises an internet server which provides secured communication to and from the Detachable Data Transceiver Device, as well as any computing device in the internet. In one embodiment, the server holds several database systems for the energy management system. In one embodiment, said databases comprise a current status database for storing a summary of the latest status of all the appliances registered in the system. In another embodiment, said databases comprise a power measurement database for storing the power consumption history of all the appliances. In yet another embodiment, said server allows the master electrical appliances and peripheral electrical appliances to be effectively located in different premises across distances apart such as in different countries around the world. In one embodiment, said server has a location database for storing the location information of mobile devices registered in the user's account. In one embodiment, this allows a kind of geo-fencing in which a mobile device reaching a certain range of locations will actuate a group of appliances to switch on or off accordingly. In one embodiment, this server also simplifies the overall networking setup of the energy management system by acting as the middleman such that any computing devices can talk to the internet server as if talking to the Detachable Data Transceiver Device directly; There is no advanced settings required for components such as router and thus allows general users to enjoy the benefits from the energy management system with minimal effort.

In another embodiment, in order to further improve user friendliness, every AC socket in the First Power Socket Devices will have a plug detection feature. Whenever an appliance has been plugged or unplugged, the user will be notified through the computer software or apps. Therefore, the user will have an immediate notification of unsecured plug insertion, or incorrect plug removal. This can protect major appliances to operate properly.

### BRIEF DESCRIPTION OF THE FIGURES

The accompanying drawings which are incorporated into and constitute a part of this specification illustrate one or more embodiments of the present invention and together with the detailed description serve to explain the principles and implementations of the invention.

FIG. 1a shows a connectivity overview of one embodiment of the present Energy Management System.

FIG. 1b shows a connectivity overview of one embodiment of a plurality of the present Energy Management System installed in multiple premises.

FIG. 2a shows an illustration for one embodiment of a power measurement device, the First Power Socket Device, and FIGS. 2b & 2c for another embodiment.

FIG. 3a shows an illustration for one embodiment where the First Power Socket Device and Second Power Socket Device are combined into a single device, and FIGS. 3b & 3c for another embodiment.

FIG. 4a shows an illustration for one embodiment of the Detachable Data Transceiver Device, and FIG. 4b for another embodiment.

FIG. 5a shows the illustration for one embodiment of the plug detection mechanism.

FIG. 5b shows the schematic diagram for one embodiment of the plug detection mechanism.

FIG. 6a shows a schematic diagram for one embodiment of the Detachable Data Transceiver Device.

FIG. 6b shows one embodiment of the software state diagram for the Detachable Data Transceiver Device.

FIG. 7a shows a schematic diagram for one embodiment of the First Power Socket Device.

FIG. 7b shows one embodiment of the software state diagram for the First Power Socket Device.

FIG. 8 shows one embodiment of the operational state diagram for the internet server.

FIG. 9 shows one experimental setup of the present System.

FIG. 10a shows the energy measurement result of a hot and cold distilled water dispenser.

FIG. 10b shows the energy measurement results of three desktop computers and one notebook computer.

FIG. 10c shows the energy measurement results of a water dispenser in a pantry and a desktop computer in an office room. They are both connected to the System under control and monitoring, but are separated far apart and do not share the same Second Power Socket/First Power Socket Device.

FIG. 11a shows the story board for one embodiment of the smart phone app design.

FIG. 11b shows the simplified software state diagram for one embodiment of the smart phone app design.

### DETAILED DESCRIPTION OF THE INVENTION

The present invention, the Energy Management System is a network system for household, offices or institutions, comprising a Detachable Data Transceiver Device together with a plurality of Power Measurement Devices.

The present invention provides a user-friendly energy management system which provides flexible functions, keep track of all energy consumption in the system and control of electrical appliances over a large range of distances. In one embodiment, said energy management system comprises: (a) a First Power Socket Device comprising (1) a plug, (2) one or more power measurement module, (3) one or more AC sockets each of which is coupled with an AC switch, (4) one or more communication modules, (5) a timing module, (6) a microcontroller, wherein said microcontroller controls the AC switches, and (7) a memory module, wherein said memory module stores control instructions for controlling the AC sockets; (b) a Second Power Socket Device comprising a plug, a docking space and one or more Detachable Data Transceiver Devices, wherein said Detachable Data Transceiver Device comprises a microcontroller, one or more communication modules, charging circuitry and battery; (c) one or more computing devices, wherein said computing device comprises a global positioning system and a software for analyzing energy consumption measurement and providing control instructions for controlling the energy consumption of the AC sockets; and (d) an internet server, wherein said internet server comprises (1) a timing module, (2) a software for analyzing energy consumption measurement and providing control instructions for controlling the energy consumption of the AC sockets, and (3) a software for preventing unauthenticated access into the system, wherein said internet server communicates with the computing device and the communication device of the Second Power Socket Device, wherein energy consumption from the AC sockets are measured by the First Power Socket Device and communicated to the internet server or computing devices via the communication device of the Second Power Socket Device, wherein control instructions from the computing devices are communicated (1) to the microcontroller in the First Power Socket Device via the communication device of the Second Power Socket Device or (2) to the internet server.

In one embodiment, the First Power Socket Device and Second Power Socket Device are combined in a single device.

In one embodiment, the AC sockets are faced towards the ground.

In one embodiment, said AC sockets further comprise a surge arrestor coupled with a surge arrestor failure detection scheme so that a remote user could be notified when the arrestor protection has been failed or tripped.

In one embodiment, said Detachable Data Transceiver Device could operate on battery when separated from the Second Power Socket Device.

In one embodiment, the communication device of the Second Power Socket Device is capable of operating under Wi-Fi in both infrastructure and ad-hoc modes for communicating wirelessly with said computing device. In another embodiment, under ad-hoc mode, the computing device can communicate with the communication device of the Second Power Socket Device from anywhere in the world having internet connection via said internet server.

In one embodiment, said Second Power Socket Device communicates wirelessly with the First Power Socket Device using Z-Wave or ZigBee wireless communication.

In one embodiment, the computing device is selected from the group consisting of a smart phone, a tablet computer, a desktop computer or a notebook computer.

In one embodiment, the energy consumption measurement data from each AC socket in the system is stored in one or more of the computing device, the internet server or the memory module in the First Power Socket Device.

In one embodiment, each of said AC sockets further comprises an electrical plug detection mechanism comprising a detection pin for electrically contacting and bridging the live or neutral prong of a device plugged in to said AC socket so that the microcontroller will detect the presence or absence of a device plugged in said AC socket and notify a user.

In one embodiment, said First Power Socket Device further comprises an indicator, which is coupled with each AC socket, that will respond to the control instructions from the computing device.

In one embodiment, said memory module is permanent memory or non-permanent memory.

In one embodiment, said energy management system is any combination of the components or devices disclosed in this specification as long as they are operationally linked together for the purpose of energy management.

The present invention also provides an energy management device. In one embodiment, the components of said energy management device are chosen from the followings: (1) a plug, (2) one or more power measurement module, (3) one or more AC sockets each of which is coupled with an AC switch, (4) one or more communication modules, (5) a timing module, (6) a microcontroller, wherein said microcontroller controls the AC switches, (7) a memory module, wherein said memory module stores control instructions for controlling the AC sockets, (8) a docking space and (9) one or more Detachable Data Transceiver Devices, wherein said Detachable Data Transceiver Device comprises a microcontroller, one or more communication modules, charging circuitry and battery.

In one embodiment, said energy management device is any combination of the components or devices disclosed in this specification as long as they are operationally linked together for the purpose of energy management.

The present invention further provides methods for energy management using the energy management system of this invention. In one embodiment, said method for energy management, comprising the steps: (i) placing the First Power Socket Device and Second Power Socket Device from one or more of the energy management systems of claim 1 at desired locations; (ii) plugging a plurality of electrical appliances into the AC sockets in the energy management systems; (iii) connecting the First Power Socket Device, the Second Power Socket Device, the internet server and the computing device wirelessly; and (iv) configuring control instructions for managing energy consumption of the electrical appliances that are plugged into the AC sockets.

In one embodiment, the First Power Socket Device and Second Power Socket Device are or are not placed at a same location.

In one embodiment, said control instructions comprise designating each of the electrical appliances as master electrical appliances or peripheral electrical appliances, wherein the peripheral electrical appliances are controlled according to energy consumption of the master electrical appliances. In another embodiment, said master electrical appliances and peripheral electrical appliances are or are not plugged into the AC sockets of the same First Power Socket Device. In a further embodiment, the master electrical appliances and peripheral electrical appliances are or are not plugged into the AC sockets in the same energy management system. In yet another embodiment, the peripheral electrical appliances are: turned off when the energy consumption of a master electrical appliance is lower than its operational need; or automatically turned on when the energy consumption of a master electrical appliance is at its operational need.

In one embodiment, said control instructions control the AC socket that electrical appliances are plugged into based on: the distance between the AC sockets and the computing device, wherein the AC sockets are switched on or off when the computing device is at a specified distance from the socket; or the time on any one of said computing device, said First Power Socket Device or internet server, wherein the AC sockets are switched on or off at a specified time; or the energy consumption of the plugged-in electrical appliance, wherein the AC sockets are switched on or off at a specified level of energy consumption.

In one embodiment, step (iii) further comprises detaching the Detachable Data Transceiver Device from the Second Power Socket Device and placing it at a location which bridges the wireless connection.

In one embodiment, the methods for energy management using the energy management system of this invention comprises the combination or sequence of any one of the steps comprising (i) placing the First Power Socket Device and Second Power Socket Device from one or more of the energy management systems of claim 1 at desired locations; (ii) plugging a plurality of electrical appliances into the AC sockets in the energy management systems; (iii) connecting the First Power Socket Device, the Second Power Socket Device, the internet server and the computing device wirelessly; and (iv) configuring control instructions for managing energy consumption of the electrical appliances that are plugged into the AC sockets as long as the method allows the energy management system of this invention to achieve the purpose of energy management.

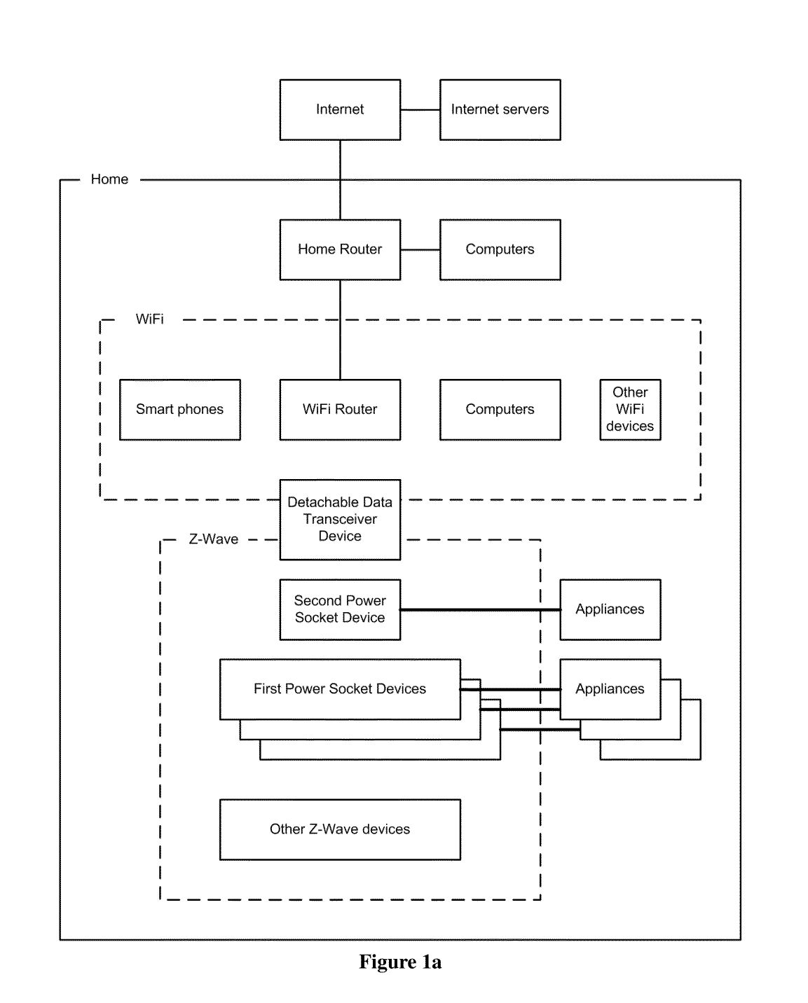

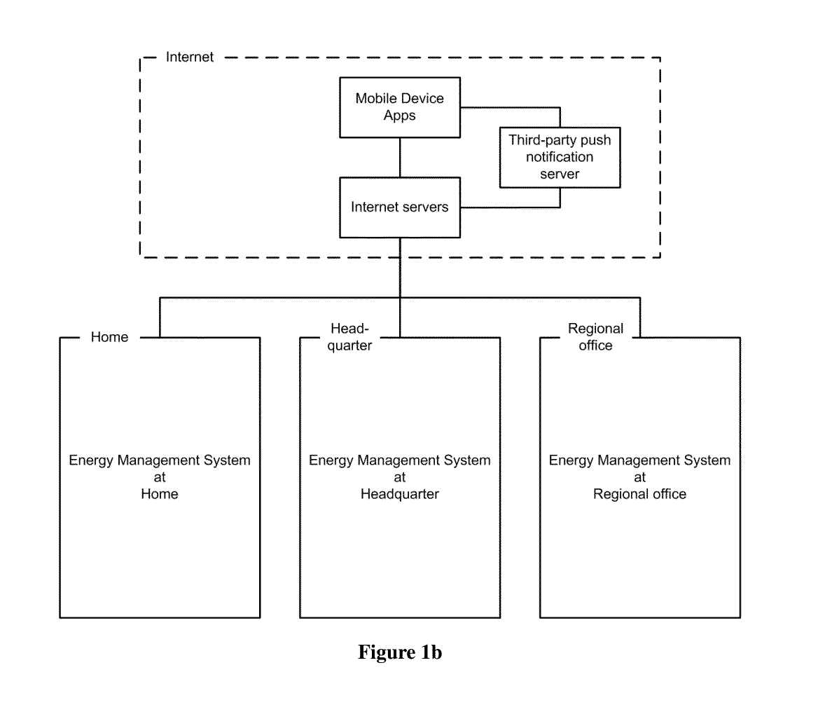

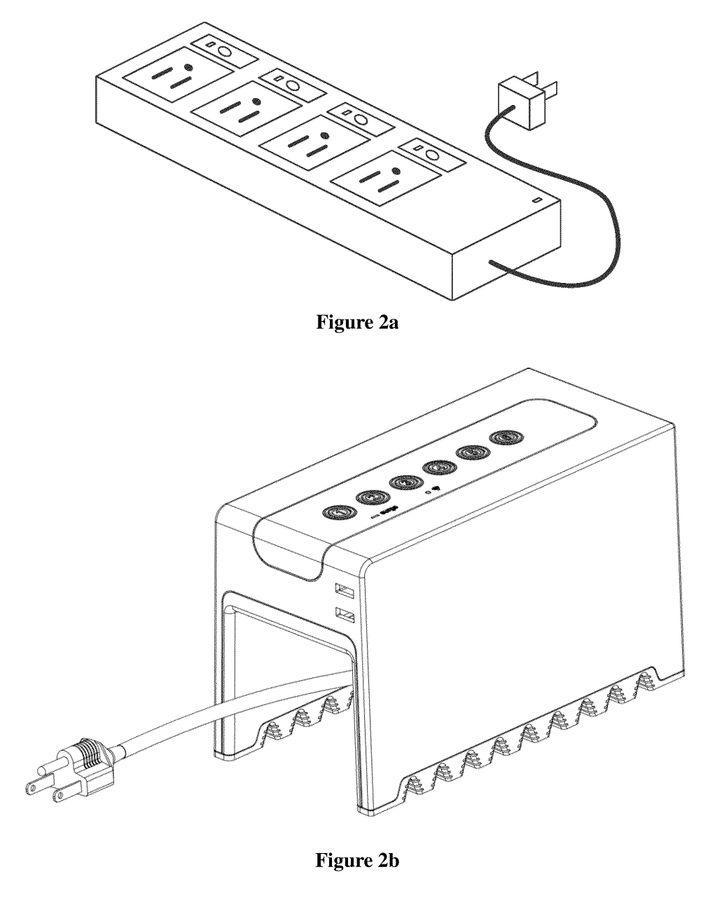

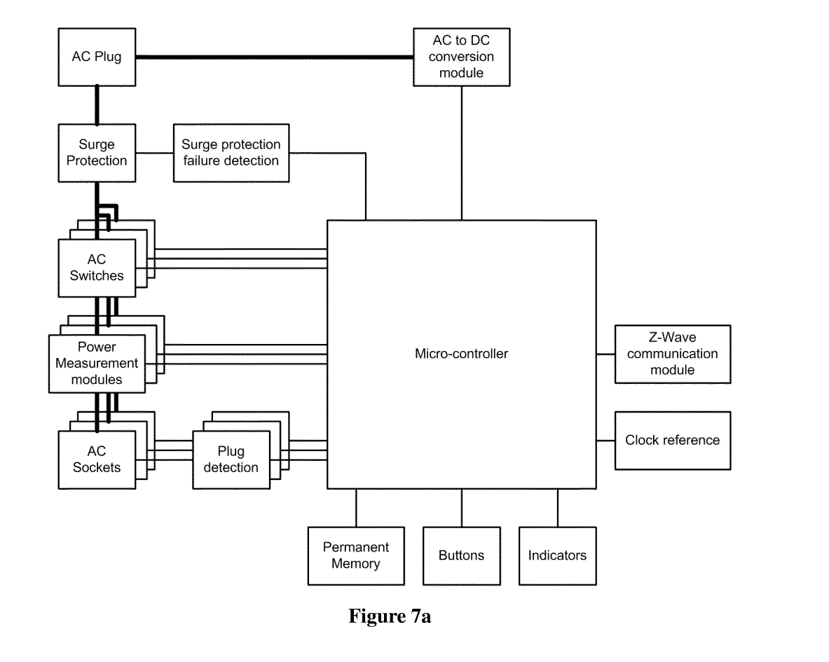

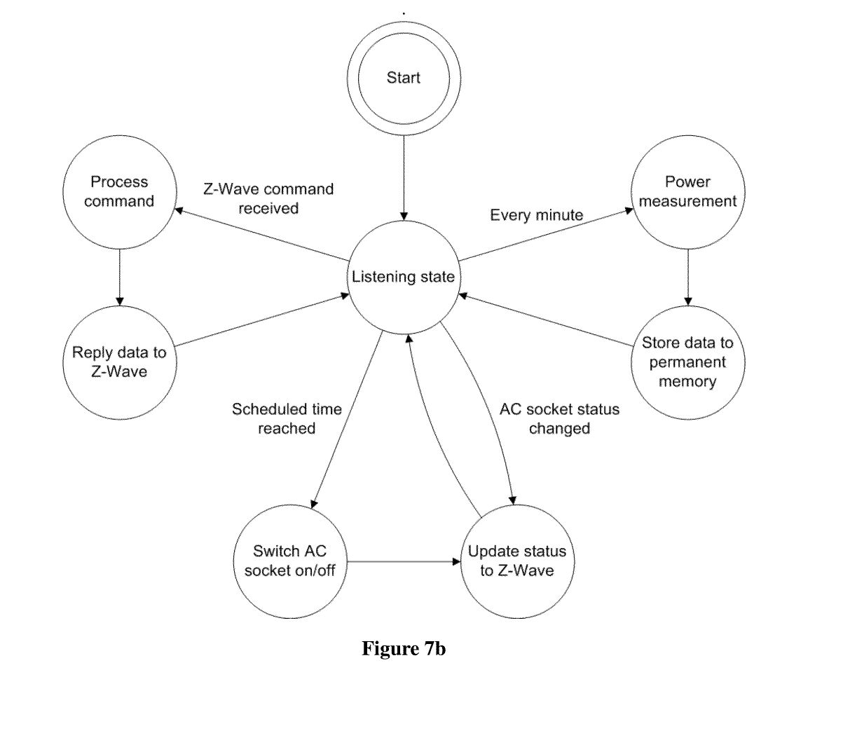

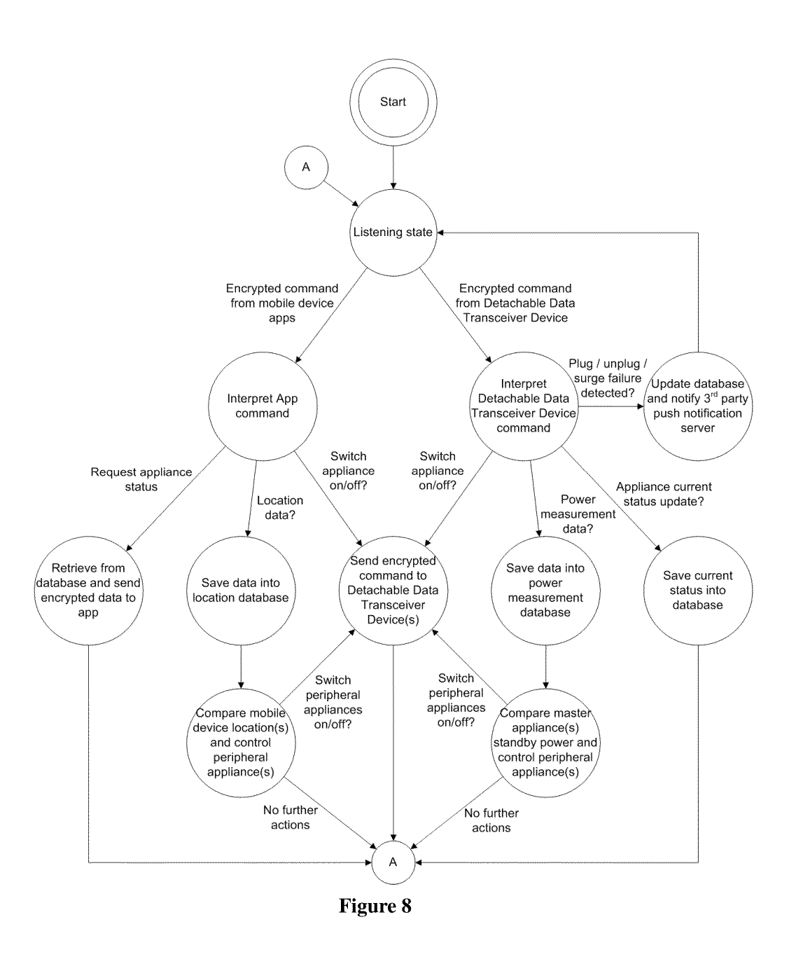

In one embodiment, the First Power Socket Device as shown in FIG. 2a has a similar construction as an ordinary power strip. FIGS. 2b & 2c show another embodiment. It has an AC plug to acquire electrical power, and can be designed to have a plurality of AC sockets to deliver electricity for any appliances plugged on it. Each of the AC sockets is associated with an electronic circuitry to measure the electrical power and an electronic switch to control the power on or off. Power measurement data will be stored in memory, for a period of time until the memory is full. In addition, there is a wireless communication module in the power measurement device for the control and data signal exchange with a Detachable Data Transceiver Device. In one embodiment, Z-Wave wireless communication module is used. Other wireless protocols generally known in the art, such as ZigBee can also be used. When it is wirelessly connected to the Detachable Data Transceiver Device of the Second Power Socket Device, the data can be transferred to computing devices such as computers, portable devices or Internet servers for analysis. In one embodiment, said First Power Socket Device comprises a timing module, which allows the appliance on each AC socket to be switched on or off according to a plurality of time schedules. In another embodiment, when a user wants to define a time schedule for an appliance which is plugged in an AC socket of the power measurement device, the user can provide control instructions through the computing device which will send the control instructions to the internet server; once the server saves the control instructions into the database, the server will also send the control instructions to the Detachable Data Transceiver Device. Finally the Detachable Data Transceiver Device forwards the control instructions to the micro-controller of the First Power Socket Device. By comparing scheduled time in the control instructions with the real-time clock, the scheduled on and/or off switching can be performed according to the control instructions. In one embodiment, the First Power Socket Device comprises a permanent memory, such as EEPROM, for storing control instructions. In another embodiment, the permanent memory enables the defined control instructions can still be observed immediately after a disruption to the normal functioning of the energy management system e.g. power outage. In another embodiment, the timing module in the First Power Socket Device allows the time-related control instructions to be reliably observed if the wireless communication with other components of the energy management system are interrupted for any reasons. In one embodiment, the operational state diagram of the Internet server is shown in FIG. 8. However, it should be noted that the First Power Socket Device can operate, measure, and store data alone, without the Second Power Socket Device. In one embodiment, FIG. 1a illustrates the connectivity diagram of the installation of the Second Power Socket Device, the First Power Socket Device inside a home environment for an embodiment of this invention wherein the Detachable Data Transceiver Device in the Second Power Socket Device is a WiFi dongle. Those appliances connected to the First Power Socket Devices are to be controlled and analyzed. In this embodiment, the Internet servers are connected to our system through the user's home WiFi router and internet router facilities. In one embodiment, FIG. 7a and FIG. 7b illustrate the block diagram of the circuitry and the software state diagram of the First Power Socket Device respectively.

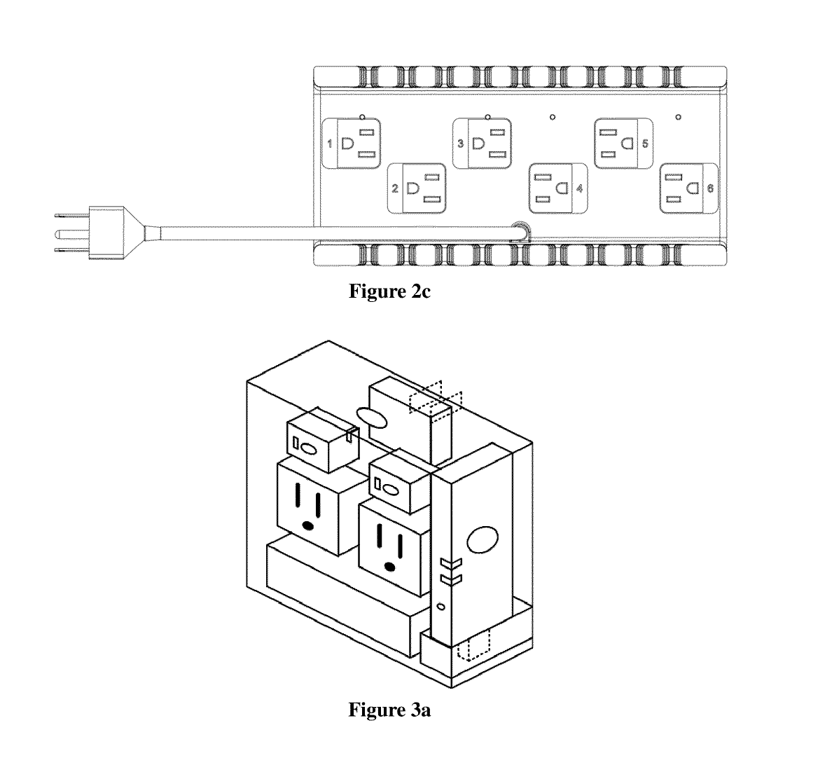

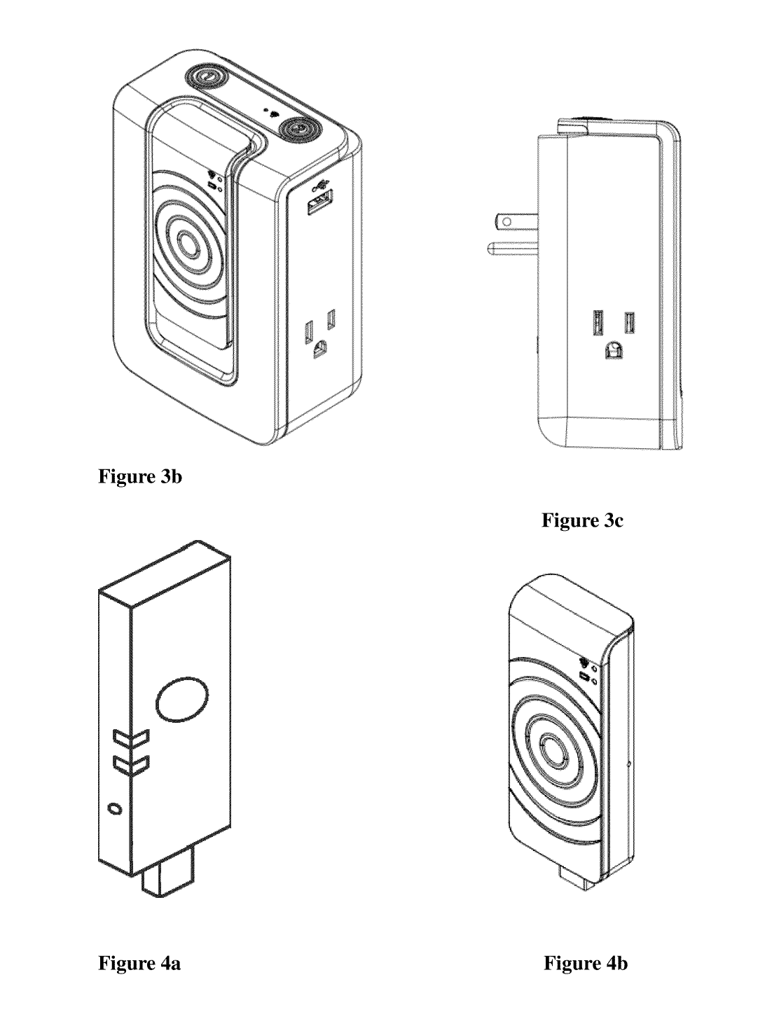

In one embodiment, the First Power Socket Device and the Second Power Socket Device are combined in a single device as shown in FIG. 3a. FIGS. 3b & 3c show another embodiment. In this embodiment, this single device can operate on its own without any further First Power Socket Device or Second Power Socket devices.

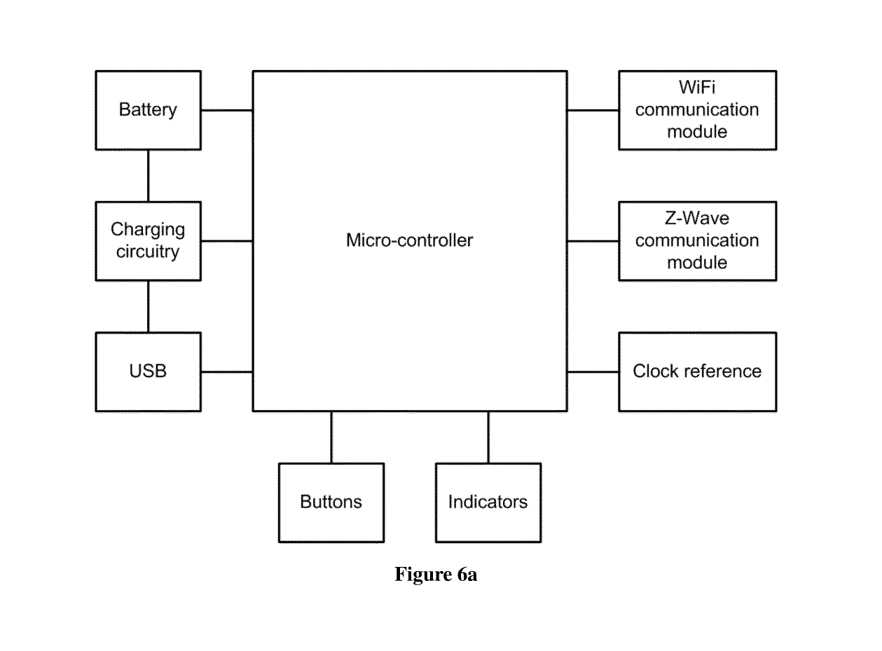

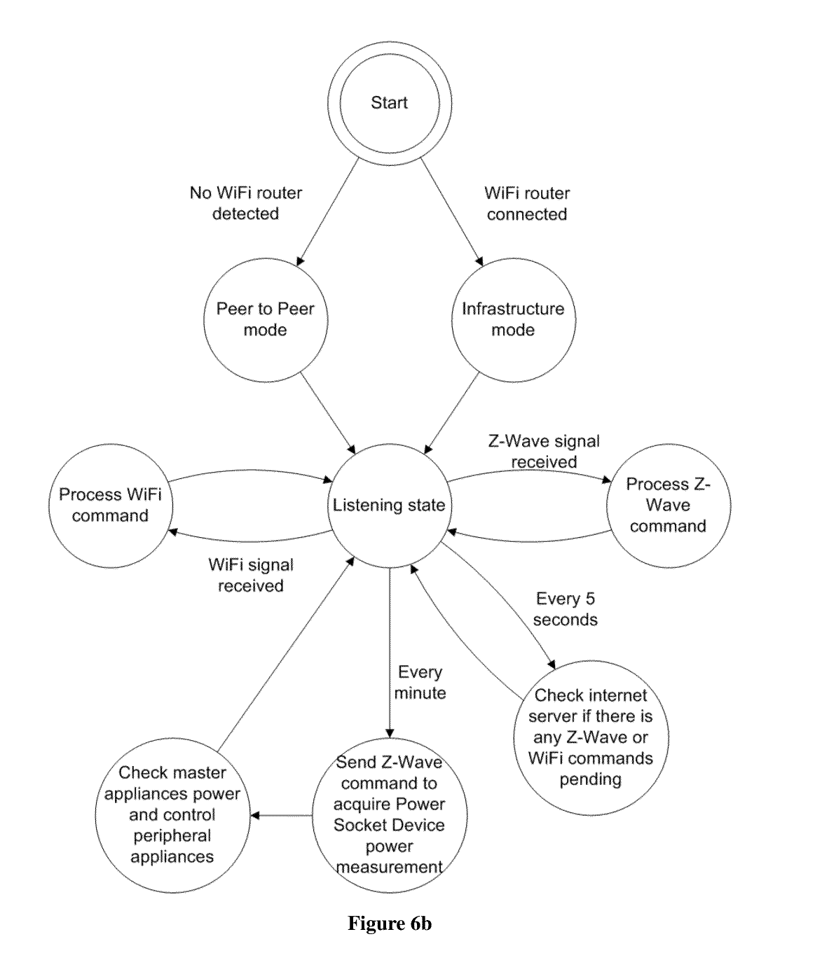

In one embodiment, the Detachable Data Transceiver Device as shown in FIG. 4a includes a Z-Wave wireless communication module as well as an industrial standard Wi-Fi module which translates the power measurement data and remote control instructions to and from the Second Power Socket or First Power Socket Devices to be accepted by computers, smart phones and tablet PC which support the Wi-Fi feature. FIG. 4b shows another embodiment. There is a built-in rechargeable battery to power the Detachable Data Transceiver Device. Besides, there is a standard USB connector to allow direct communication with computers through the USB bus. The battery charging is also supported through the USB bus power from this USB connection. FIG. 6a and FIG. 6b illustrate the block diagram of the circuitry and the software state diagram of the Detachable Data Transceiver Device respectively.

In one embodiment, the Detachable Data Transceiver Device supports two operating modes offered by the Wi-Fi standard, namely ad-hoc and infrastructure modes. The ad-hoc is a peer-to-peer mode. It operates solely and directly between the Detachable Data Transceiver Device and the computing devices such as computers, smart phones, or tablet PC. On the contrary, the infrastructure mode involves a third party wireless router as a central hub to route data traffic among the Detachable Data Transceiver Device, computing devices, as well as the Internet which allows remote access away from home. Any wireless system, including Wi-Fi, has a coverage problem or blind spots caused by long distance, walls attenuation, or interference. To solve this shortcoming, the Detachable Data Transceiver Device (with a Wi-Fi module) can be detached from the Second Power Socket Device. The battery powered Detachable Data Transceiver Device can then be brought close to the blind spots, and switched to ad-hoc (peer-to-peer) mode so as to directly communicate with the computers, smart phones, or tablet PC to solve the coverage problem. Moreover, if there is no existing home or office Wi-Fi network, the present System is capable of using the ad-hoc mode to create a new Wi-Fi network. In addition, prior to using the infrastructure mode, the ad-hoc mode is used to pass the Wi-Fi authentication information, such as SSID and password, to the Detachable Data Transceiver Device.

After Wi-Fi authentication, the Wi-Fi module on the Detachable Data Transceiver Device can be linked up with a software application on computers, smart phones or tablet PC. When the Second Power Socket or First Power Socket Device is plugged into the AC mains, it will notify the Detachable Data Transceiver Device wirelessly and the Detachable Data Transceiver Device will update the software application via Wi-Fi. The location of this Second Power Socket or First Power Socket Device (such as kitchen or bedroom) will be prompted by the software application.

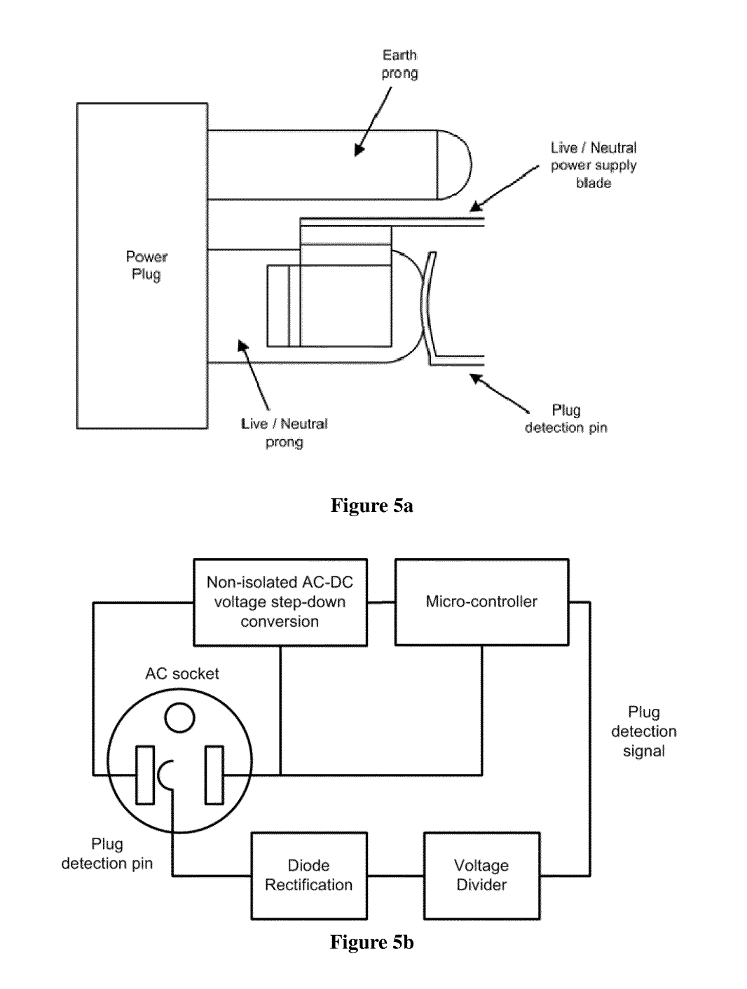

In one embodiment, there is a plug and unplug detection mechanism, by either electrical, mechanical or optical mean, implemented to each AC socket of the First Power Socket Device to check the presence of an AC plug to the socket. When an appliance has been plugged into the First Power Socket Device, a similar wireless process will notify the software application to prompt for a name (such as TV or computer) for this newly included appliance. In one embodiment, the plug and unplug mechanism can be detected electrically (see FIGS. 5a & 5b). When the live or neutral prong of an appliance's power plug is inserted into the AC socket in full position, the prong will make an electrical contact with the detection pin, and then bridge the live or neutral to the detection pin. The micro-controller will sense the rectified and stepped down voltage and/or the 50/60 Hz AC frequency from the detection pin to judge the plug is inserted or not.

In one embodiment, a dedicated computer connected in the internet is used as the internet server for the energy management system. In one embodiment, said server provides encrypted communication, e.g. an industrial standard HTTPS protocol, to and from the Detachable Data Transceiver Device, as well as the computing device. In another embodiment, the server comprises software for user authentication login process so as to maintain a higher standard of security to prevent intruders from issuing illegal commands or modifying the integrity of any commands or data being sent to a user's home. In one embodiment, for data storage, the server holds one or more database systems for the energy management system. In another embodiment, said databases comprise one or more of a current status database, a power measurement database, and a mobile device location database. In one embodiment, the current status database stores a summary of the latest status of all the appliances registered in the system under a user's login account. In another embodiment, said appliance status includes one or more of its name, photo, location, on/off state, recent power consumption, time schedule setting, grouping setting, etc. This feature is important that when a user launches a mobile app, the server can readily provide a quick and accurate summary regarding all the appliances' near real-time status in the system, instead of a time consuming process of requesting every appliance in the system one by one. Similarly, whenever each appliance in the system changes any status and/or setting, the updated data will immediately be sent to the server, and the server will then update its database accordingly. In one embodiment, said power measurement database stores the past power measurement data of every appliance at a regular time interval. In another embodiment, said power measurement database provides the user about any appliance's power consumption history in the past. In one embodiment, the server can also digest, summarize and compare the power consumption history to generate customized reports to help user to make energy saving plans, and to review the saving results. In one embodiment, the Detachable Data Transceiver Device will collect the power measurement data from each appliance and then sends to the server for storage. In one embodiment, to achieve the master-peripheral appliance grouping control, the server will compare the latest power consumption data of all the master appliances, and then determines whether they are below corresponding standby power, if so, the server will send control instructions to switch off corresponding peripheral appliances to actively save power from peripheral appliances. In one embodiment, allows the master electrical appliances and peripheral electrical appliances to be effectively located in different premises across distances apart such as in different countries around the world. In one embodiment, there is one more database to store the location information of computing devices registered in the user's account. In another embodiment, a software in the computing device, such as a mobile app installed in a mobile device, will monitor the location information (usually from Global Positioning System GPS, or from cellular network information, or from WiFi neighbourhood information) given by the computing device at regular time intervals and send this location information to the server, the server will store this into the database and will compare this with a predetermined location where the electrical appliance(s) is/are located. In one embodiment, when these two locations are within a predefined distance, the server will send control instructions to the Detachable Data Transceiver Device so that those electrical appliances can be switched to a predefined on/off state accordingly. In another embodiment, when these two locations are far away, those electrical appliances will be switched to another pre-determined state based on the control instructions. In one embodiment, this is known as geo-fencing. In one embodiment, when the server receives certain notification updates from the Detachable Data Transceiver Device on the status of the energy management system, e.g. an AC socket plugged/unplugged, or a surge failure, the server will initiate a push notification request to a third-party push notification server so as to immediately pop up a notification in one or more computing devices, e.g. mobile devices, registered in the user's account. In one embodiment, this server simplifies the overall networking setup of the energy management system. In conventional home control or monitoring scenarios, for a computing device from the internet (outside home) to go through a home internet router to reach another computing device in the home intranet (inside home), there exists certain advanced networking techniques, such as port-forwarding and network address translation, to be configured in the home router. In the present invention, the internet server acts as the middleman such that all devices in the system, including the outside home device e.g. computing devices and the inside home device e.g. the Detachable Data Transceiver Device, are all talking to the internet server. In this way, since the devices do not talk to each other directly, There is no advanced settings required for components such as router and thus allows general users to enjoy the benefits from the energy management system with minimal effort.

In many situations power strips are put on the floor and behind or underneath furniture. With weak lighting surrounding, all the power plugs look similar. Worst of all, usually all those lengthy power cables are tangled altogether. When the user is going to unplug one appliance for relocation, the identification of the power plug to the corresponding appliance is very difficult, and usually resulting in mistakes. A desktop computer could be accidentally unplugged and all unsaved works will be lost, and even worse the operating system may crash. To this end, our system is designed with a finding socket feature. As each appliance is prompted with a name when it has been plugged, its name is mapped in the system with the corresponding AC socket. In one embodiment, through the application running on the portable device, when the user invokes the finding socket feature for that appliance, in one embodiment, the system blinks the AC socket's power indicator so that the user can correctly identify which AC socket is with that appliance and can unplug it safely without any guesswork.

Sensitive and valuable appliances are usually protected by surge arrestors. When there is a lightning, the arrestor absorbs the over-voltage energy to prevent the appliance from damage. However, when the energy absorbed by the arrestor is larger than that it can sustain, the arrestor will fail and usually a fuse will be tripped to disconnect the appliance from the mains, but the outage may not be observed by users. In one embodiment, is the system of the present invention not only provides a conventional surge arrestor, but also an arrestor comprising failure detection scheme. Once a failure is detected, the First Power Socket Device will immediately notify the Second Power Socket Device with the Detachable Data Transceiver Device wirelessly (e.g. WiFi), and then the Internet Server. The server will send a message to a third-party push notification server (for example, a smart phone system provider), then a push notification will immediately notify a smart phone app with a plurality of users registered with the system. Those users can take immediate actions to tackle the outage to guarantee the service.

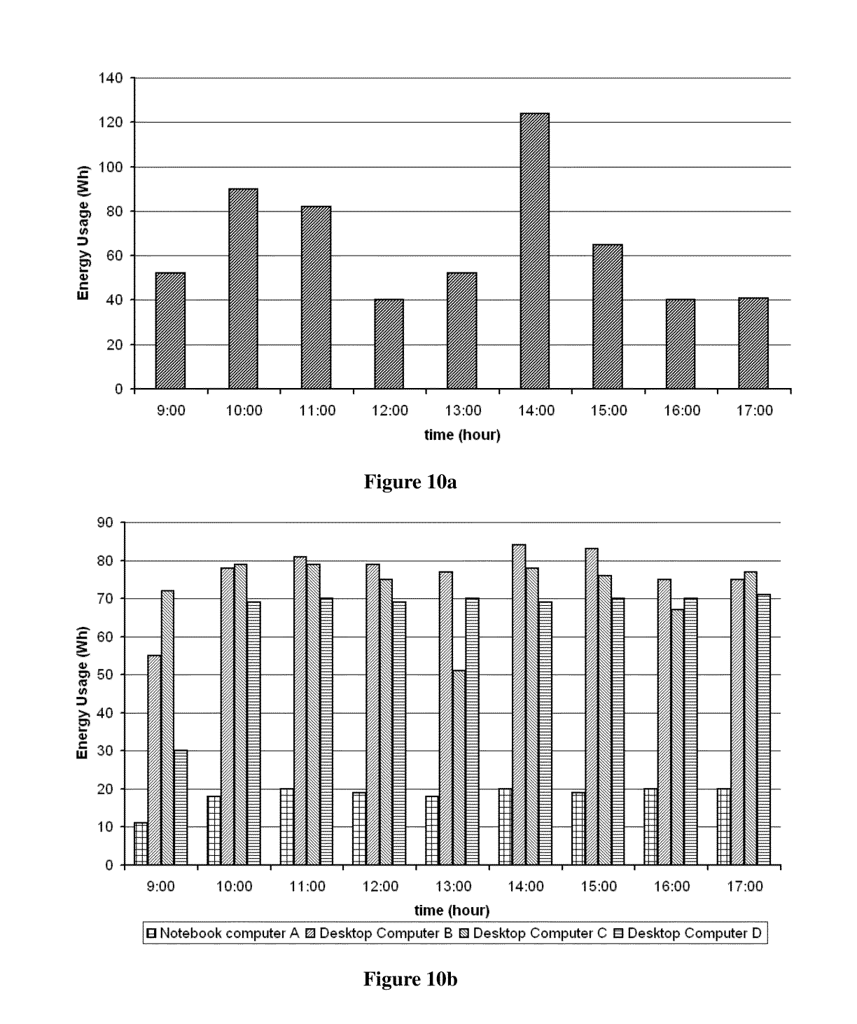

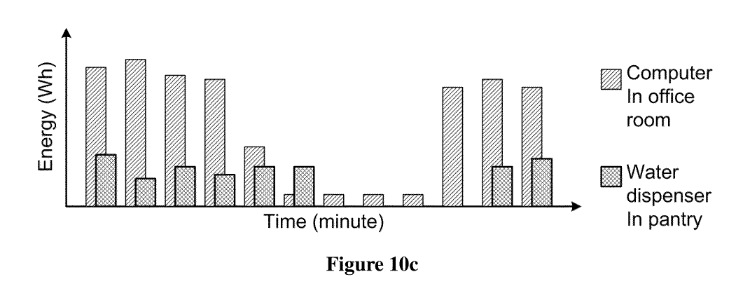

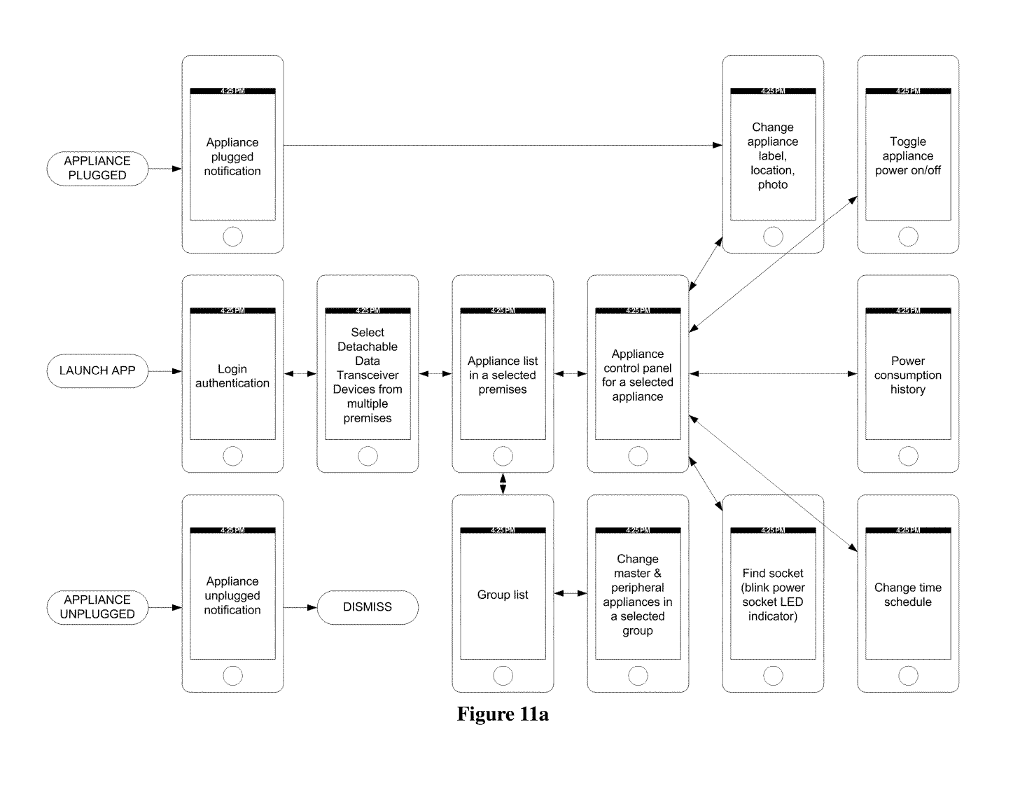

In one embodiment, the software application provides a user interface to display the power measurement and on/off status for each appliance in the system. Each appliance can be switched on or off through the software application remotely. The software application also supports a plurality of user defined schedules for each appliance. Once the schedule is enabled, the system will follow the schedule and will automatically switch the appliance on and off according to the time set. The instantaneous power and the power consumption history in the past can also be retrieved to display through the software application. Analysis can also be made to provide graphical power usage per minute, per hour, per day, per week, per month, or per year to review the usage pattern of an individual appliance (see e.g. FIG. 10a & FIG. 10b). In another embodiment, power usage per location, such as living room, kitchen, or bedroom can be made. Power usage per category, such as computer & peripherals, TV & Hi-Fi, can also be consolidated. With the electricity usage information collected from most of the appliances, a summary report of usage pattern, temporal distribution, break-down by areas (e.g. rooms) and categories can be generated for review. Corresponding target saving plans can be optimized to any individual area, category or appliance. Electricity consumption can thus be reduced accordingly.

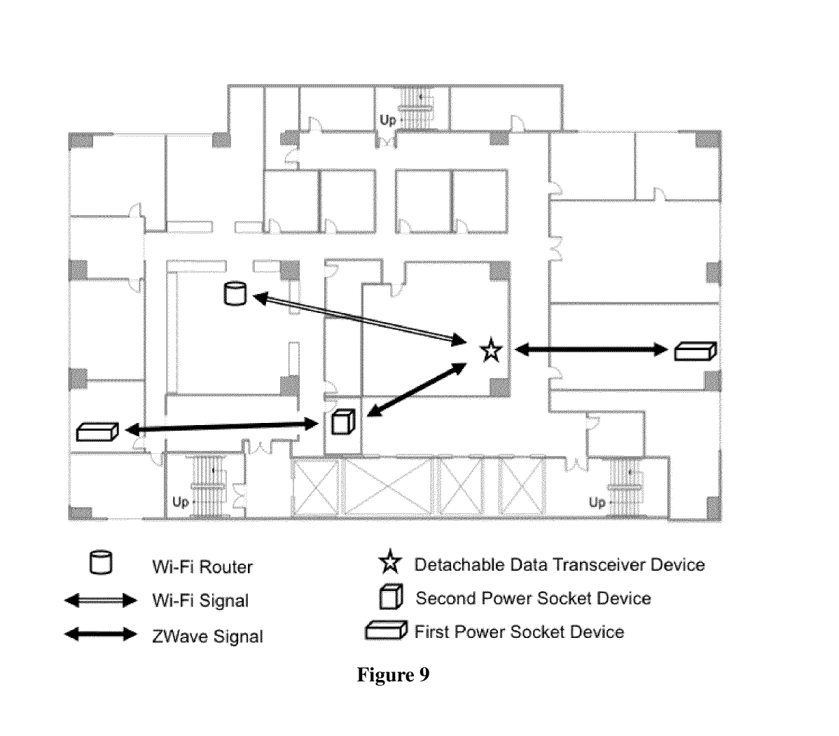

As each of the appliances has its unique identification name, a plurality of appliances can be grouped as master, for which their power will be monitored. Another plurality of appliances can be grouped as peripheral, for which their power will be switched on or off automatically depending on the power measured from the master group. The appliances, no matter the master or the peripheral groups, can be plugged in the First Power Socket Devices separated anywhere at home or office (see e.g. FIG. 9). For example, a configuration can be set to have a hot & cold distilled water dispenser (in pantry) automatically switched off when all computers in an office room are consuming standby power only (see e.g. FIG. 10c). In another embodiment, through the app in the mobile device, a configuration can be set to have a network printer & computer speaker automatically switched off when the notebook computer are consuming standby power only. This is to provide minimal effort and less intervention required by the users to maintain effective and efficient energy saving. The system supports a special case that the master and peripheral appliance can be the same appliance, such as a mobile phone charger. When the charging completes and standby power appears, the system determines the charger is in standby state and can automatically switch off the charger to cut the standby power. In another day, when the mobile phone needs to be charged again, simply switch on the AC socket where the charger is in and the system will allow the charger to operate as the power consumption is higher than the standby threshold. This implementation is useful to save power consumption for appliances like battery chargers which operate few hours but will enter standby for 1 to 2 days.

A location based home automation service is that a plurality of appliances can be defined by the user such that when the user's portable device is leaving the proximity of the system's installation premises, such as home, these appliances can be automatically switched off (such as lighting), or on (such as burglary security alarm). This proximity information is updated by the GPS location data given by the portable device to the system server in the Internet. The switch on/off process will be reversed when the user's portable device is returning to the said premises.

A scene control service is that a plurality of appliances can be grouped by the user such that when the scene is enabled or disabled, that group of appliances will be switched on, off, or dimmed altogether. In one embodiment, the scene can be set as “sleep”. When it is enabled, most lighting and Television will be switched off, while certain lighting in corridors will be dimmed.

When any of the included appliance is unplugged, the unplug detection mechanism will be triggered to notify the software application. Then the user will be prompted to confirm if this is intended to do so. This is to avoid improper plug insertion and wrong plug disconnection.

In one embodiment, the present invention provides an Energy Management system capable of determining one or a plurality of primary or master electrical appliances being in standby state, and then automatically switches off a plurality of user defined peripheral appliances across different First Power Socket Devices located in different locations. In reverse, when the primary appliance resumes in operation, those peripheral appliances are switched on automatically.

When a plurality of the system are implemented in multiple premises, the master and peripheral appliances can be separated widely at any physical locations around the world, provided they are all connected to the internet. For example, a video storage network shared hard drive (in a company's headquarter) can be automatically switched when the associated computers (in regional sales offices) are all in standby or off. FIG. 1b illustrates another example of the connectivity of the system installed in 3 different locations.

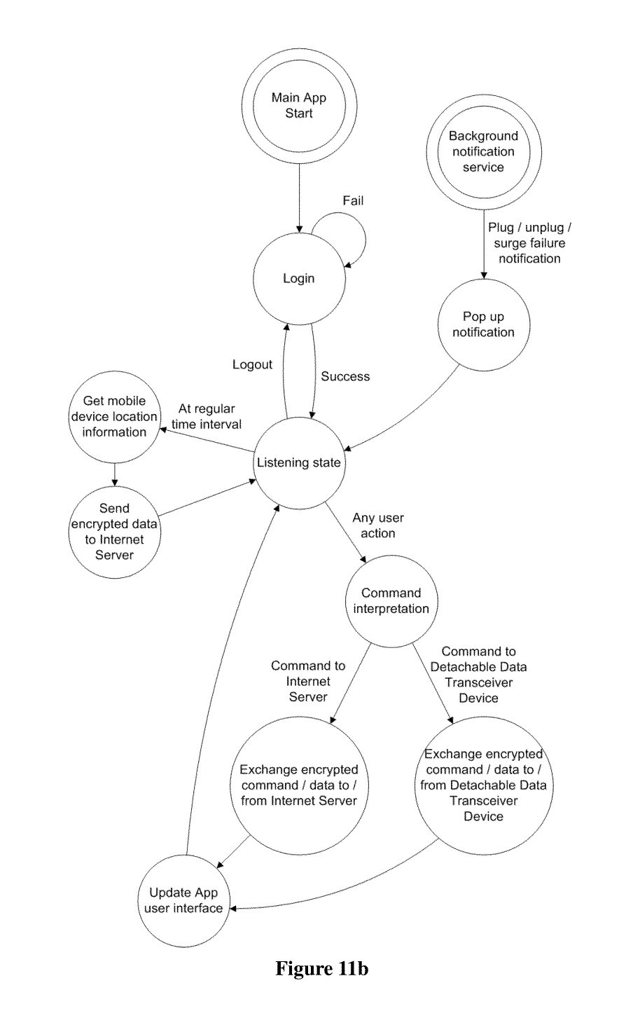

In one embodiment, a software such as a mobile device app is used in implementing some of the functions of the energy management system. A simplified story board of one embodiment of a mobile app is illustrated in FIG. 11.

In one embodiment, there is provided an energy management system comprising (a) one or more power measurement device, each of which comprises a communication module, a micro-controller, and one or more AC sockets, each of said socket is connected to a power measurement module; (b) one or more Detachable Data Transceiver Device for wireless communication; and (c) a plurality of master and peripheral appliances plugged into said AC sockets, wherein energy consumption of said appliances are measured by the power measurement device and communicated to a computer or portable device (e.g. a smart phone or a tablet PC etc) via the Detachable Data Transceiver Device, wherein depending on the power consumption of the master appliances, the peripheral appliances could be switched on or off remotely via software on said computer or portable device. In one embodiment, the software provides a user interface to manage energy measurement data and control the operation of the master and peripheral appliances. In one embodiment, the master and peripheral appliances are located in the same location. In another embodiment, the master and peripheral appliances are not located in the same location.

In one embodiment, the AC sockets of the First Power Socket Device further comprise a plug detection feature so that a user would be notified when an appliance is plugged into or unplugged from said sockets. In another embodiment, the AC sockets further comprise a surge arrestor failure detection scheme so that a remote user could be notified when the arrestor protection has been failed or tripped.

In one embodiment, the Detachable Data Transceiver Device is not attached to a Second Power Socket Device. In another embodiment, the Detachable Data Transceiver Device is reversibly attached to a Second Power Socket Device which comprises a docking space and a battery charging circuitry for said Detachable Data Transceiver Device.

In one embodiment, the Detachable Data Transceiver Device communicates wirelessly with a computing device such as a computer or portable device using Wi-Fi. For example, the Detachable Data Transceiver Device is capable of operating under Wi-Fi in both infrastructure and ad-hoc modes. In another embodiment, the Detachable Data Transceiver Device communicates wirelessly with the First Power Socket Devices using Z-Wave or ZigBee wireless communication.

In one embodiment, the present energy management system comprises one or more devices which combined both First Power Socket Device and Second Power Socket Devices. In another embodiment, the present energy management system comprises one or more Second Power Socket Devices and one or more First Power Socket Devices. In another embodiment, a First Power Socket Device can communicate directly with the Detachable Data Transceiver Device operating separately from other components of the Second Power Socket Device, i.e. the system comprises one or more First Power Socket Devices and one or more Detachable Data Transceiver Devices.

In one embodiment, the peripheral electrical appliances are switched off automatically when the master electrical appliances are in standby state. In another embodiment, the peripheral electrical appliances are switched on automatically when the master appliances resume operation.

Although a detailed description of one preferred embodiment of the present disclosure has been expressed using specific terms and devices, but those skilled in the art will readily appreciate that the specific examples are for illustrative purposes only and should not limit the scope of the invention which is defined by the claims which follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

What is claimed is:

1. An energy management system comprising
(a) a first power socket device comprising (1) a plug, (2) one or more power measurement module, (3) one or more AC sockets each of which is coupled with an AC switch, (4) one or more communication modules, (5) a timing module, (6) a microcontroller, wherein said microcontroller controls the AC switches and (7) a memory module, wherein said memory module stores control instructions for controlling the AC sockets;
(b) a second power socket device comprising a plug, a docking space and one or more detachable data transceiver devices, wherein said detachable data transceiver device comprises a microcontroller, one or more communication modules, charging circuitry and battery;
(c) one or more computing devices, wherein said computing device comprises a global positioning system and a software for analyzing energy consumption measurement and providing control instructions for controlling the energy consumption of the AC sockets; and
(d) an internet server, wherein said internet server comprises (1) a timing module, (2) a software for analyzing energy consumption measurement and providing control instructions for controlling the energy consumption of the AC sockets, and (3) a software for preventing unauthenticated access into the system, wherein said internet server communicates with the computing device and the communication device of the second power socket device,
wherein energy consumption from the AC sockets are measured by the first power socket device and communicated to the internet server or computing devices via the communication device of the second power socket device, wherein control instructions from the computing devices are communicated (1) to the microcontroller in the first power socket device via the communication device of the second power socket device or (2) to the internet server.

2. The energy management system of claim 1, wherein the first power socket device and second power socket device are combined in a single device.

3. The energy management system of claim 1, wherein the AC sockets are faced towards the ground.

4. The energy management system of claim 1, wherein said AC sockets further comprise a surge arrestor coupled with a surge arrestor failure detection scheme so that a remote user could be notified when the arrestor protection has been failed or tripped.

5. The energy management system of claim 1, wherein said detachable data transceiver device could operate on battery when separated from the second power socket device.

6. The energy management system of claim 1, wherein the communication device of the second power socket device is capable of operating under Wi-Fi in both infrastructure and ad-hoc modes for communicating wirelessly with said computing device.

7. The energy management system of claim 6, wherein under ad-hoc mode, the computing device can communicate with the communication device of the second power socket device from anywhere in the world having internet connection via said internet server.

8. The energy management system of claim 1, wherein said second power socket device communicates wirelessly with the first power socket device using Z-Wave or ZigBee wireless communication.

9. The energy management system of claim 1, wherein the computing device is selected from the group consisting of a smart phone, a tablet computer, a desktop computer or a notebook computer.

10. The energy management system of claim 1, wherein the energy consumption measurement data from each AC socket in the system is stored in one or more of the computing device, the internet server or the memory module in the first power socket device.

11. The energy management system of claim 1, wherein each of said AC sockets further comprises an electrical plug detection mechanism comprising a detection pin for electrically contacting and bridging the live or neutral prong of a device plugged in to said AC socket so that the microcontroller will detect the presence or absence of a device plugged in said AC socket and notify a user.

12. The energy management system of claim 1, wherein said first power socket device further comprises an indicator, which is coupled with each AC socket, that will respond to the control instructions from the computing device.

13. The energy management system of claim 1, wherein said memory module is permanent memory or non-permanent memory.

14. A method for energy management, comprising the steps:
i. placing the first power socket device and second power socket device from one or more of the energy management systems of claim 1 at desired locations;
ii. plugging a plurality of electrical appliances into the AC sockets in the energy management systems;
iii. connecting the first power socket device, the second power socket device, the internet server and the computing device wirelessly; and
iv. configuring control instructions for managing energy consumption of the electrical appliances that are plugged into the AC sockets.

15. The method of claim 14, wherein the first power socket device and second power socket device are or are not placed at a same location.

16. The method of claim 14, wherein said control instructions comprise designating each of the electrical appliances as master electrical appliances or peripheral electrical appliances, wherein the peripheral electrical appliances are controlled according to energy consumption of the master electrical appliances.

17. The method of claim 16, wherein said master electrical appliances and peripheral electrical appliances are or are not plugged into the AC sockets of the same first power socket device.

18. The method of claim 16, wherein the master electrical appliances and peripheral electrical appliances are or are not plugged into the AC sockets in the same energy management system.

19. The method of claim 16, wherein the peripheral electrical appliances are:
i. turned off when the energy consumption of a master electrical appliance is lower than its operational need; or
ii. automatically turned on when the energy consumption of a master electrical appliance is at its operational need.

20. The method of claim 14, wherein said control instructions control the AC socket that electrical appliances are plugged into based on:
i. the distance between the AC sockets and the computing device, wherein the AC sockets are switched on or off when the computing device is at a specified distance from the socket; or
ii. the time on any one of said computing device, said first power socket device or internet server, wherein the AC sockets are switched on or off at a specified time; or
iii. the energy consumption of the plugged-in electrical appliance, wherein the AC sockets are switched on or off at a specified level of energy consumption.

21. The method of claim 14, wherein step (iii) further comprises detaching the detachable data transceiver device from the second power socket device and placing it at a location which bridges the wireless connection.
